(19) United States
(12) Patent Application Publication
(10) Pub. No.: US 2009/0038980 A1
(43) Pub. Date: Feb. 12, 2009

(54) Insulated tank assembly with insulation stop and method of assembly thereof

(76) Inventors: Anthony L. Rockwell, Pickerington, OH (US); Christopher B. Schechter, Knoxville, TN (US); Scott A. Campen, Knoxville, TN (US)

Correspondence Address: OWENS CORNING, 2790 COLUMBUS ROAD, GRANVILLE, OH, 43023, US

(21) Appl. No.: 11/890,359

(22) Filed: Aug. 6, 2007

(51) Int. Cl. B65D 90/04; B23P 19/00; B65D 8/18; B65D 81/38

(52) U.S. Cl. 206/524.6; 220/4.21; 220/592.25; 29/700

(57) ABSTRACT

An insulated tank assembly with insulation stop and a method of constructing such an assembly. The assembly includes an inner tank with an outer shell located in spaced relation to and surrounding the inner tank, creating at least one annular clearance space between the tank and the shell. The space is closed by a sealing device that includes a circumferential sealing strip having an unstretched strip length that is less than either the continuous outer top edge length or the continuous outer bottom edge length, or both, of the strip. Such length relationships make the sealing strip both resilient and resistant to rolling during construction of the assembly. The sealing strip may be a fibrous strip. The tank assembly may be insulated by placing insulating material within the at least one annular clearance space, which may be a foamable insulation material, foamed in place within the annular clearance space.

### TECHNICAL FIELD AND INDUSTRIAL APPLICABILITY OF THE INVENTION

The invention relates to the field of insulated tank assemblies, and in particular to an assembly utilizing an improved insulation stop for the retention of foam insulation within such an assembly.

### BACKGROUND OF THE INVENTION

Insulated tank assemblies, such as water heaters and other devices, have long been known in the art. The term “tank” is used in its broadest sense in this disclosure, to define any container having a volume, and therefore, one skilled in the art will realize that the assembly, components, and methods described herein are equally applicable to other tank assemblies such as dish washers, refrigerators, storage tanks, and innumerable other insulated containers.

Such assemblies typically comprise an inner storage tank or vessel and an outer shell or jacket. Typically, but not exclusively, the inner storage tank and outer shell are cylindrical, with the outer shell disposed concentrically over the inner storage tank. There is typically at least one space formed between the inner storage tank and the outer shell, and also typically, this space is filled with insulation. While there are essentially no limitations on the types of insulation that may be disposed in such a space, a common construction technique is to inject an expanding polymer foam into the space between the tank and the shell, wherein the foaming of the polymer fills all or part of the space. Polyurethane foams are commonly used, and would be well known to one skilled in the art, while various types of epoxy and polyolefin foams have also been utilized.

More specifically, a reactive polymer composition may be injected into the space between the inner tank and the outer shell, and allowed to expand so that the resulting foam accommodates around any structure within the space and essential fills all of the available space. The polymer foam is initially fluid and sticky. As it slowly expands to fill the space, it becomes increasingly more solid. As the polymerization reaction reaches completion, the polymer foam becomes stiff and stabilizes into rigid, closed cell foam that fills the at least one space surrounding the tank and forms an insulation around the tank. Such insulation is particularly important in assemblies designed for the storage of temperature-critical contents, such as hot water heaters or refrigerators. Such insulation is also important for its sound deadening qualities in such assemblies as automatic dish washers. The amount of liquid polymer composition injected into the annular space is calculated to be sufficient only to ensure that the annular space is filled with polymer foam without creating excessive over-pressure in the space. However, to insure that the space is completely filled, sufficient foam must be injected to completely fill the space, and such foam, as it expands, must therefore be contained during the foaming and curing process.

A number of issues arise with such construction techniques. Since a common construction involves slipping an outer shell circumferentially over an inner tank, the annular space created between the two will remain open at the bottom, unless a separate bottom is placed to close the space. Secondly, tanks may have a number of inlet, outlet, and drain fittings, as well as electronic or other controls that may need to traverse the annular space. Additionally, many polymer foams used for insulation purposes are either flammable or easily damaged by heat, and must be kept a safe distance from any heating elements.

It is presently common practice to provide a foam stop device in the annular space between the inner tank and outer shell at a selected position along the height of the tank. More specifically, the foam stop is compressed between the outer wall of the inner tank and the inner wall of the outer shell so as to seal the space. Foam is then injected into the closed space above the foam stop and the stop retains the foam within the space.

In a commonly used construction, as seen by way of example in U.S. Pat. No. 5,509,566, the stop resembles a doughnut or shaped ring of various profiles that blocks the egress of foam insulation past the stop. Accordingly, the outside wall of the inner tank, the stop, and inside wall of the outer shell form a closed space that may be filled with the insulating polymer foam. The compressive sealing engagement of the stop between the tank and the shell prevents the polymer foam from entering the lower portion of the annular space, which may include a heating chamber or burner. Various additional stops may be provided around certain areas, such as controls, as may be seen for example in U.S. Pat. Publication No. 2004/0261728.

In particular, the prior art has sought, with limited success, to control two issues related to insulation stops for insulated tank assemblies. The first involves a mechanical issue related to the insulation stop itself. It is desirable that the insulation stop have a small but definite degree of elasticity, or resilience. This allows the stop to be stretched over an inner tank during assembly while maintaining a close fit to such an inner tank. Also, a degree of resilience allows the stop to be stretched over irregularities or protuberances on the tank surface, and then be allowed to retract back to maintain a close fit around the tank.

It is also desirable that the insulation stop not roll as an outer shell in placed over an inner tank. When the stop is affixed to the inner tank, and the outer shell is slid into place over the stop, the stop is compressed between the tank and the shell. Sliding the shell into place can cause the stop to roll, sometimes irregularly, as the frictional forces resulting from the compression of the stop act on the surface of the stop.

Increasingly, interest has been shown in making such insulation retaining stops from fibrous materials, such as those seen in U.S. Pat. Publication Nos. 2003/0176131 and 2004/0261728. Such fibrous materials may be entirely or partially nonflammable, and have excellent thermal and acoustic insulation properties.

These and other needs of the art are addressed by the instant invention, as disclosed in the specification and claims below.

### SUMMARY OF THE INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The present invention is an insulated tank assembly with insulation stop and a method of constructing such an assembly. A sealing device includes a circumferential sealing strip having an unstretched strip length that is less than either the continuous outer top edge length or the continuous outer bottom edge length, or both, of the strip.

The sealing strip may be a fibrous material strip, and may be formed of a single unjointed piece, or may have a joined first end and a second end. It is even possible to form the sealing strip from multiple pieces, and joined areas may be secured with adhesive or thermally bonded joints, a wide variety of mechanical fasteners, or even tape.

Such a sealing device is well suited to the construction of an insulated tank assembly that includes an inner tank with an outer shell located in spaced relation to and surrounding the inner tank. This spaced relation defines at least one annular clearance space between the inner tank and the outer shell.

A sealing strip as described above would lie in the annular clearance space, and would most commonly be placed by stretching a fully formed sealing strip over the inner tank and sliding it, including sliding it over any irregularities or protuberances in the inner tank, into position on the inner tank.

Commonly, but not necessarily, the sealing strip would be attached to the inner tank and the outer shell would be slid into place over the inner tank and the sealing device. One skilled in the art will realize that in a common embodiment, that is, a circular tank encased in a circular shell, the sealing strip would generally have a uniform thickness in order to seal a uniform annular clearance space width properly. However, there is no necessity for such a uniform annular clearance space width. As is disclosed below, the thickness of the sealing strip merely needs to conform to any significant variations in the annular clearance space width.

In such stretching and positioning maneuvers, a construction of the sealing strip whereby the strip length is less than either the continuous outer top edge length or the continuous outer bottom edge length, or ideally both, may be desirable. Any construction where the strip length is less than both of the continuous outer top edge length and the continuous outer bottom edge length, will have an intrinsically elastic nature, given at least a slightly elastic material substrate. For example, in an illustrated embodiment in which the seal strip has “V” shaped dentate portions, stretching the strip will cause the open v-like notches of the dentate portions to open slightly, and thereby to elongate the overall strip. In other illustrated embodiments, the same effect may be observed with serpentine-type constructions and others.

The construction in which the strip length is less than either the continuous outer top edge length or the continuous outer bottom edge length, also has advantages. Sliding the outer shell over the inner tank while compressing the sealing strip between the inner tank and the outer shell causes frictional interactions between the sealing strip and the walls of the inner tank and the outer shell that can cause the sealing strip to roll or otherwise be displaced from its intended position. A sealing device according to the instant invention has a resistance to rolling compared to the planar, ring-like constructions seen in the prior art. This is due to the fact that a strip in which the strip length is less than either the continuous outer top edge length or the continuous outer bottom edge length is necessarily non-planar, that is, that all points on at least one of these edges do not lie on a single plane. In particular, it has been seen that the “dentate” construction as illustrated in a preferred embodiment is particularly resistant to rolling.

To assist in keeping the sealing strip in its predetermined position, the sealing strip may be affixed to the inner tank by adhesive before the shell is slid onto the tank. Additionally or alternatively, in other embodiments, the at least one annular clearance space may include one or more abutment members providing a positioning stop for the sealing device. A chamfer may be present along an edge selected from the edges consisting of the outer top edge and the outer bottom edge of the sealing strip in order to ease the passage of the outer shell over the inner tank.

Once the outer shell is in desired position, the tank assembly may be insulated by placing insulating material within the at least one annular clearance space. In a common embodiment, the insulating material is a foamable insulation material, foamed in place within the annular clearance space. In order to retain such foam within the annular clearance space, the sealing strip has an uncompressed thickness slightly greater than the at least one annular clearance space width, and a compressed thickness essentially equal to the at least one annular clearance space width. In various embodiments, the sealing strip may be formed of more than a single layer, with the layers having different densities, and may be formed with or without a facing layer.

### BRIEF DESCRIPTION OF THE DRAWINGS

Without limiting the scope of the present invention as claimed below and referring now to the drawings and figures, all of which are not to scale:

FIG. 1 is a section view of an insulated tank assembly according to the prior art;

FIG. 2a is an elevation view of an embodiment of a sealing device, prior to assembly, according to the instant invention;

FIGS. 2b-e are elevation views of alternate embodiments of the sealing device according to FIG. 2a, prior to assembly, according to the instant invention;

FIG. 3a is a series of elevation views of various embodiments of the sealing device of FIG. 2a, prior to assembly, illustrating various first and second end configurations, according to the instant invention;

FIG. 3b is a perspective end view of an embodiment of the sealing device of FIG. 2a, prior to assembly, illustrating various end configurations, according to the instant invention;

FIG. 4 is a top plan view of the sealing device of FIG. 2a, prior to assembly, according to the instant invention;

FIG. 5 is a bottom plan view of the sealing device of FIG. 2a, prior to assembly, according to the instant invention;

FIG. 6 is a top plan view of the sealing device of FIG. 2a, assembled and ready for installation, according to the instant invention;

FIG. 7 is an elevation view of the sealing device of FIG. 2a, assembled and ready for installation, according to the instant invention;

FIG. 8 is a bottom plan view of the sealing device of FIG. 2a, assembled and ready for installation, according to the instant invention;

FIG. 9 is a perspective view of the sealing device of FIG. 2a, assembled and ready for installation, according to the instant invention;

FIG. 10 is a perspective view of the sealing device of FIG. 2a, prior to assembly, according to the instant invention, illustrating continuous outer top edge length and continuous bottom edge length;

FIG. 11 is a partial section perspective view of one embodiment of an insulated tank assembly according to the instant invention;

FIG. 12 is a section view of the embodiment of an insulated tank assembly as seen in FIG. 11;

FIG. 13 is an elevation view of an alternate embodiment of a sealing device, prior to assembly, according to the instant invention, illustrating continuous outer top edge length and continuous bottom edge length;

FIG. 14 is an elevation view of an alternate embodiment of a sealing device, prior to assembly, according to the instant invention, illustrating continuous outer top edge length and continuous bottom edge length;

FIG. 15 is an elevation view of an alternate embodiment of a sealing device, prior to assembly, according to the instant invention, illustrating continuous outer top edge length and continuous bottom edge length;

FIG. 16 is a partial section perspective view of an alternative embodiment of an insulated tank assembly according to the instant invention;

FIG. 17 is a top plan view of the alternative embodiment of an insulated tank assembly according to FIG. 16; and

FIG. 18 is an end perspective view of alternate embodiments of the instant invention, illustrating multiple layers and a facing layer.

These drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION AND PREFERRED EMBODIMENTS OF THE INVENTION

The insulated tank assembly with insulation stop and method of assembly of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

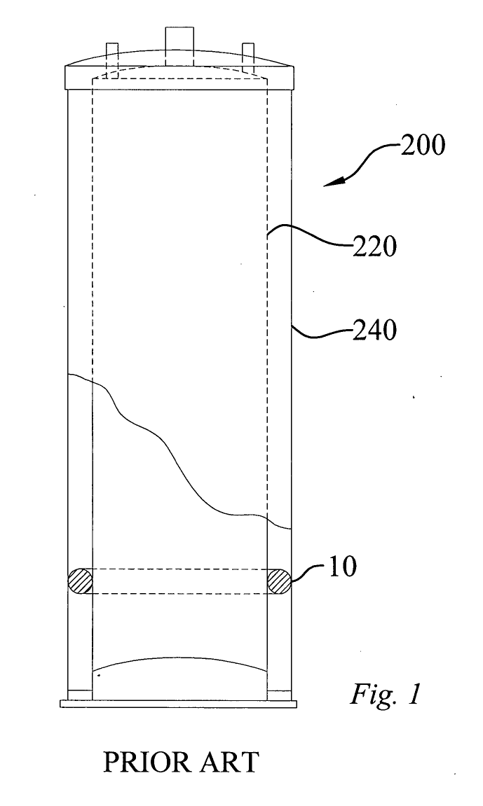

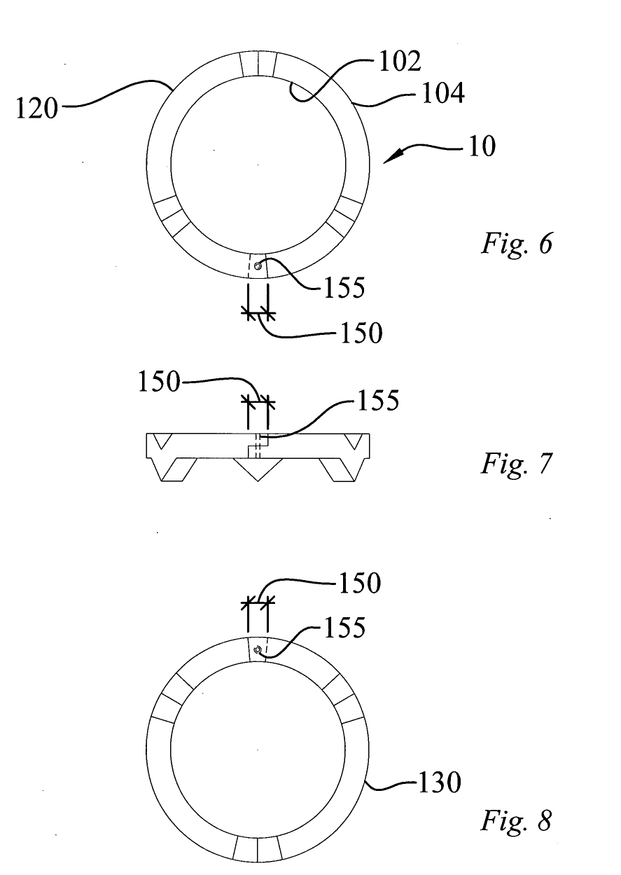

With reference generally now to FIGS. 1 through 18, the instant invention is an insulated tank assembly with insulation stop, and a method of construction for such an assembly. A typical prior art example of such an assembly is seen in FIG. 1.

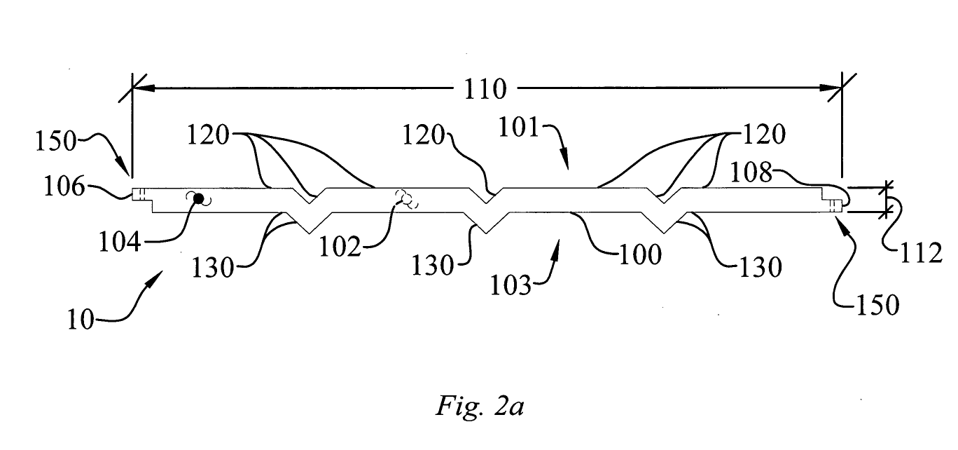

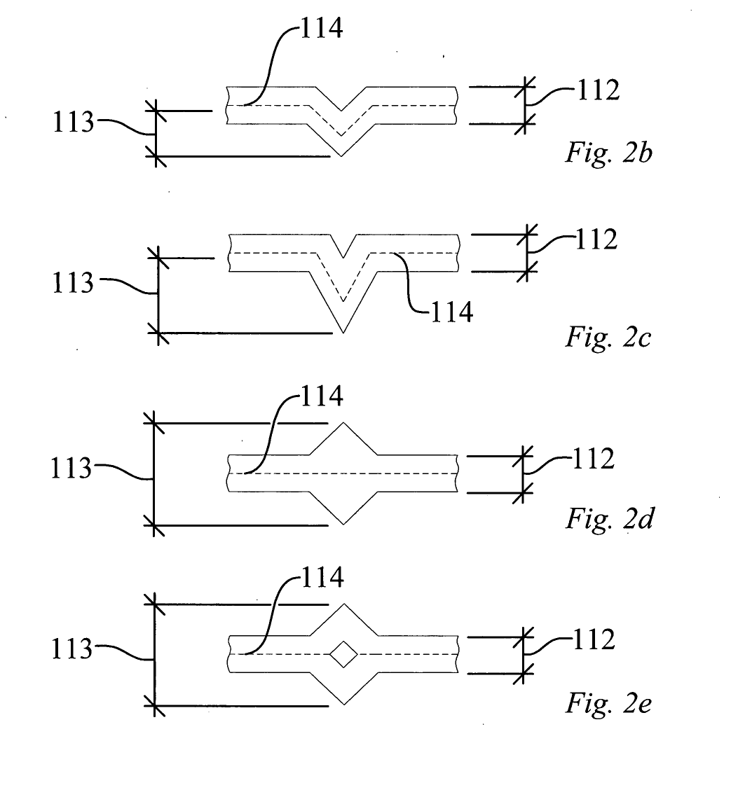

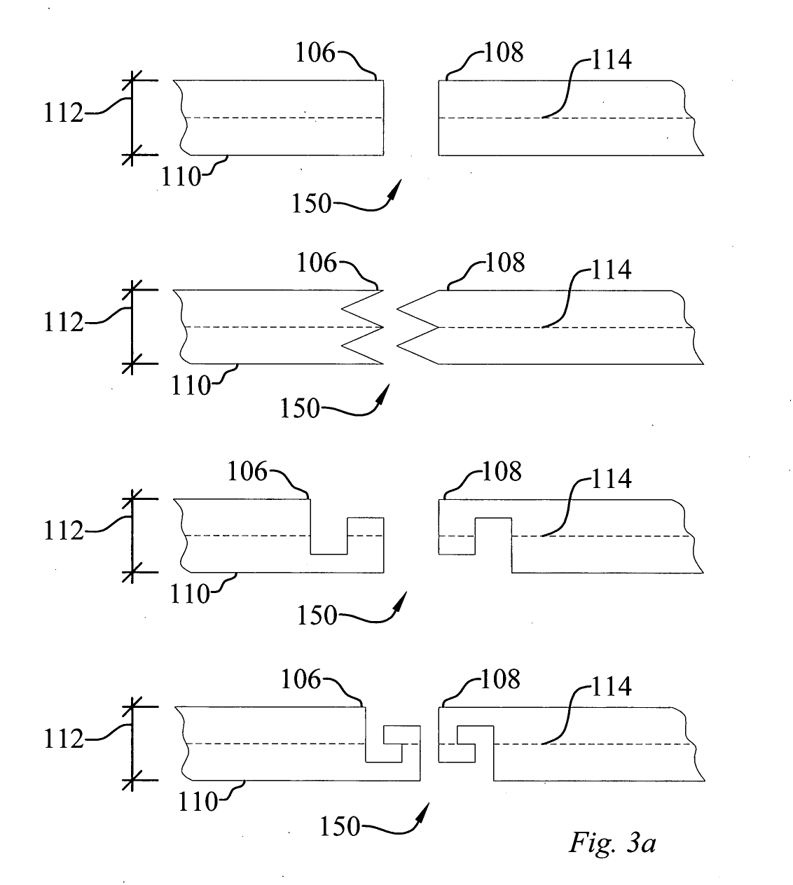

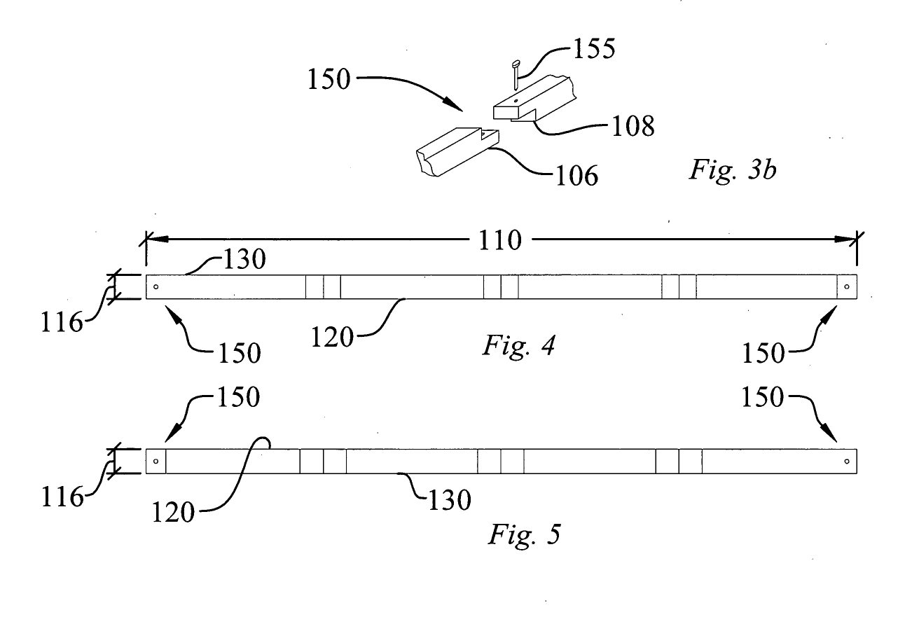

What is claimed, as seen well in one embodiment in FIG. 2a, is a sealing device (10) including a circumferential sealing strip (100) having a top aspect (101), an inner surface (102), a bottom aspect (103) and an outer surface (104). The sealing device (10) also includes a strip length (110), at least one strip height (112) having a sealing strip height midline (114), as seen in FIGS. 2a-e and FIG. 3a, and at least one strip thickness (116). One skilled in the art will realize that there may be a plurality of strip heights (112) and plurality of strip thicknesses (116), as will be discussed at greater length below. As also seen in FIGS. 2a-9, the sealing device (10) may also have an outer top edge (120) having a continuous outer top edge length (122) and an outer bottom edge (130) having a continuous outer bottom edge length (132). In certain embodiments, such as a sealing strip (100) with a triangular cross section, is may be possible for the outer top edge (120) and the outer bottom edge (130) to be the same, and therefore for the outer top edge length (122) and the outer bottom edge length (132) to be the same.

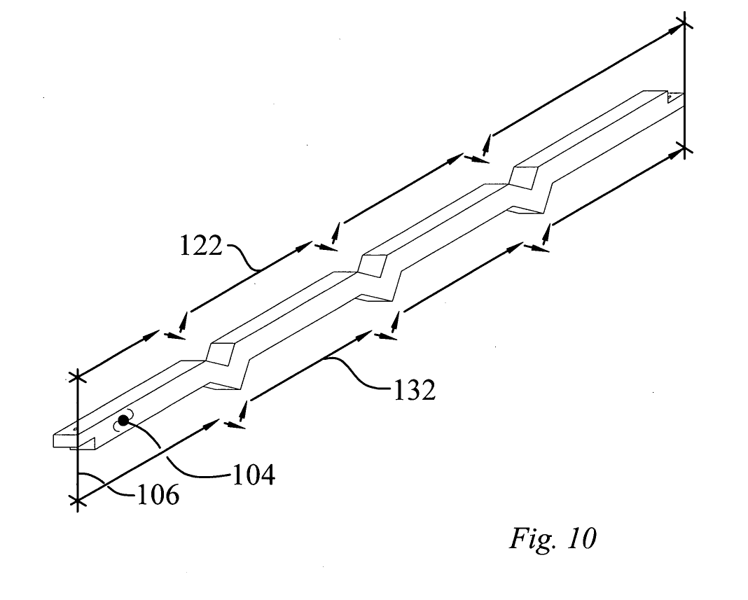

The strip length (110) is less than one of the lengths selected from a group of lengths consisting of the continuous outer top edge length (122) and the continuous outer bottom edge length (132), as seen in FIGS. 2a, 10 and 13-15. FIGS. 10 and 13-15 emphasize and illuminate the definition of this specification that the continuous outer top edge length (122) and the continuous outer bottom edge length (132) are measured by following the running distance along the edge surfaces of the outer top edge (120) and outer bottom edge (130). For this same reason, the terms “continuous” are used to emphasize that such lengths (122, 132) are measured as running distances along the edges (120, 130), as illustrated in FIG. 10, rather than as representing the shortest distance between any particular points on the outer surface (104). This is to be contrasted with strip length (110), which does represent the shortest circumferential distance around the outer surface (104), as seen in FIGS. 2a, 4, and 5.

One skilled in the art will immediately recognize that in any circumferential structure with an inner and an outer surface, and having thickness or width, the circumference of such a circumferential structure depends at the-point within the thickness or width at which such circumference is measured.

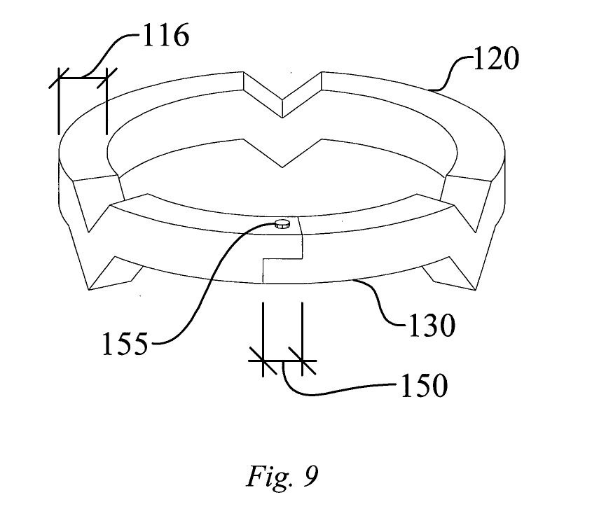

According to the well-known formula, C=πd, the circumference (C) of a circular structure is equal-to the constant π (approximately 3.14159) multiplied by the diameter (d). For example, a circular, ring-like, structure such as seen in FIG. 9, having a strip thickness (116) of one inch and an outer diameter of two feet, is approximately 6.28 inches lesser in circumference along its inner surface (102) than along its outer surface (104), due to the two inch difference in the diameter between opposing points on the inner surface (102) compared to the diameter between opposing points on the outer surface (104).

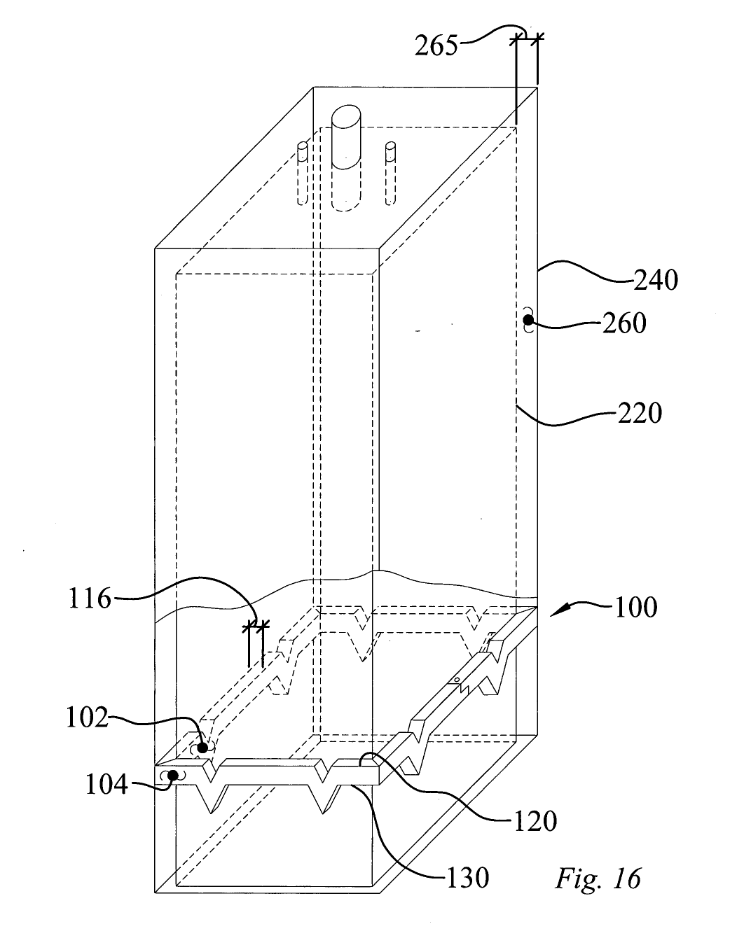

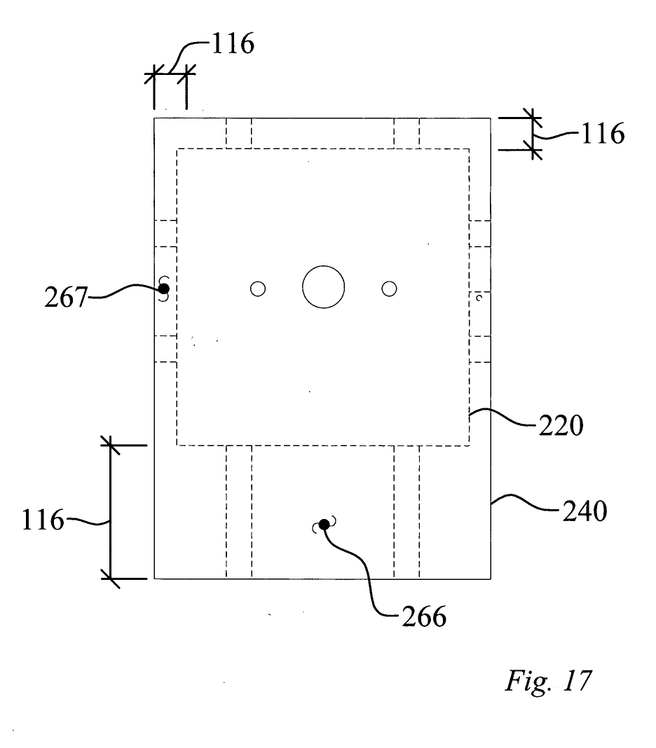

By way of further example, for a rectangular structure having sides and thickness, the difference in circumference between the inner and outer surfaces of the structure is equal to the difference in the sum of the internal and external lengths. For example, a rectangular structure such as seen in FIGS. 16-17, being two feet in outside length on each side and having a wall thickness of one inch, has an internal circumference that is eight inches less than its external circumference.

Thus, for the sake of clarity and consistency in this specification, the terms “strip length (110),” shall mean the length measured at the outer surface (104) of the circumferential sealing strip (100) most radially distant from an imaginary center. The “continuous outer top edge length (122),” and “continuous outer bottom edge length (132)” shall mean the running length(s) measured at the most radially distant edges at the top aspect (101) and the bottom aspect (103) of the circumferential sealing strip (100) from an imaginary center, and shall be referenced as the “outer top edge (120)” and the “outer bottom edge (130).” All lengths (110, 122, 132) shall reflect the length(s) of such a circumferential sealing strip (100) at rest, in an uninstalled state, as seen well in FIG. 9. One skilled in the art will appreciate that the terms “top” and “bottom” are relative, and are only meant to convey opposed aspects of the strip height (112).

As noted, there may be multiple sealing strip heights (112, 113) including at least a sealing strip height (I 12) and a secondary sealing strip height (113), as seen in FIGS. 2a-e. In one particular embodiment, seen in FIG. 2d-e, the sealing strip (100) has at least one strip height (112) measured for any given radial point on the outer surface (104) as a vertical height between the top aspect (101) and the bottom aspect (103), and at least one secondary strip height (113), measured similarly, and wherein the secondary strip height (113) is at least 10% greater than the strip height (112). For the purposes of this specification, strip height (112, 113) is defined for any given radial point on the outer surface (104) as a vertical height between the top aspect (101) and the bottom aspect (103), as seen in FIGS. 2b-e.

One skilled in the art will even see, as shown in FIG. 2e, that the strip (100) need not be solid, although such constructions may be disfavored for their obvious tendency to leave uninsulated areas in any cut-out sections.

The sealing strip (100) may be a fibrous material strip made from a material selected from a group consisting of polyester, polyethylene, polypropylene, polyethylene terephthalate, glass fibers, natural fibers and any mixture thereof. In another embodiment, the sealing strip (100) may be a fibrous material strip made from a material selected from a group consisting of (a) thermoplastic polymer staple fibers and thermoplastic bicomponent fibers, (b) glass staple fibers and thermoplastic bicomponent fibers and (c) a combination of (a) and (b).

The fibrous material forming the sealing strip (100) may have various material qualities that may include a material density of about 0.8 lbs./ft³ to about 15.0 lbs./ft³ and a strip thickness (116) in the range of about 2.110 to about 5.0120 cm.

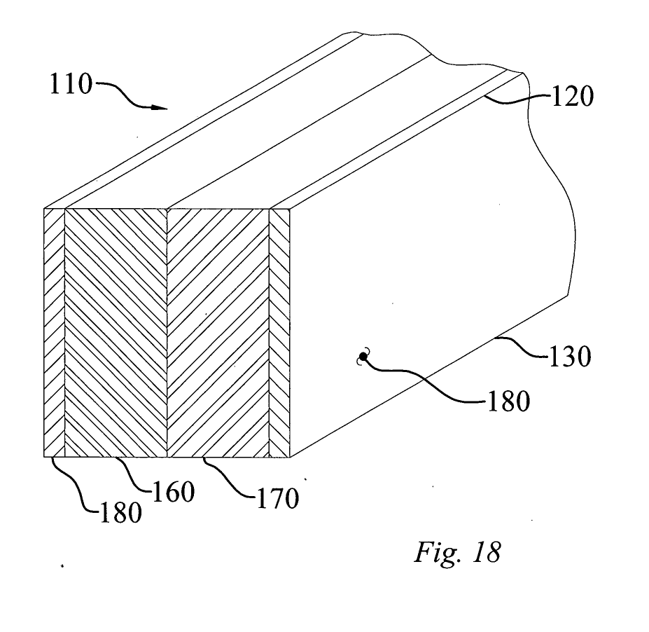

There is no requirement that the sealing strip (100) be of a uniform material construction, and as seen in FIG. 18, various embodiments utilize strips (100) of varying composition. By way of example only, in one embodiment, the sealing strip (100) further comprises at least a first layer (160) having a density of between about 1.5 lbs./ft³ to about 30.0 lbs./ft³ and a second layer (170) having a density of between about 0.8 lbs./ft³ to about 15.0 lbs./ft³. The first layer (160) may lie on the inner surface (102) or the outer surface (104), as may the second layer (170), depending on the construction desired.

In another embodiment, the sealing strip (100) further comprises at least a first layer (160) formed of fiberglass and a second layer (170) formed of a polymer material. In yet another embodiment, the sealing strip (100) further comprises at least one facing layer (180) on the sealing strip (100), as seen in FIG. 18. This facing layer may be formed of polyester, rayon, metallic foil and mixtures thereof; or any other material as would be know to one skilled in the art, and may be on the inner surface (102), the outer surface (104) or both. As will be discussed below, forming a sealing strip (100) with different density layers (160,170) may be beneficial in various assemblies utilizing such strips (100). The facing layer (180) may also lie on the inner surface (102), the outer surface (104), or both, as needed.

The sealing strip (100) may be formed of a single unjointed piece, or may have a first end (106) and a second end (108), as seen well in FIGS. 2a-9 and 12-17, where the first end (106) and the second end (108) are joined at a joining area (150). In such a jointed embodiment, the joining area (150) may further include a joining area fastener (155), seen well in FIGS. 3b, 7, and 9; securing the first end (106) and the second end (108) at the joining area (150). It is even possible to form the sealing strip (100) from multiple pieces, and the strip (100) accordingly would have multiple joining areas (150) and possibly multiple joining area fasteners (155).

The joining area (150) or joining areas may be joined, by way of example only, and as seen in FIG. 3a and 3b, with adhesive or thermally bonded joints, a wide variety of mechanical fasteners, or even tape. The geometry utilized in such joining areas may comprise butt, lap, finger, or scarfed joints, or any other geometric configuration thought desirable to effect a solid joint. In particular, as seen in FIG. 3a and as would be known to one skilled in the art, various configurations of the sealing strip (100) at the first end (106) and the second end (108) may enlarge the area available for adhesive joining, or by way of example only, interlocking the ends may allow for an increased strength in the joining area (150).

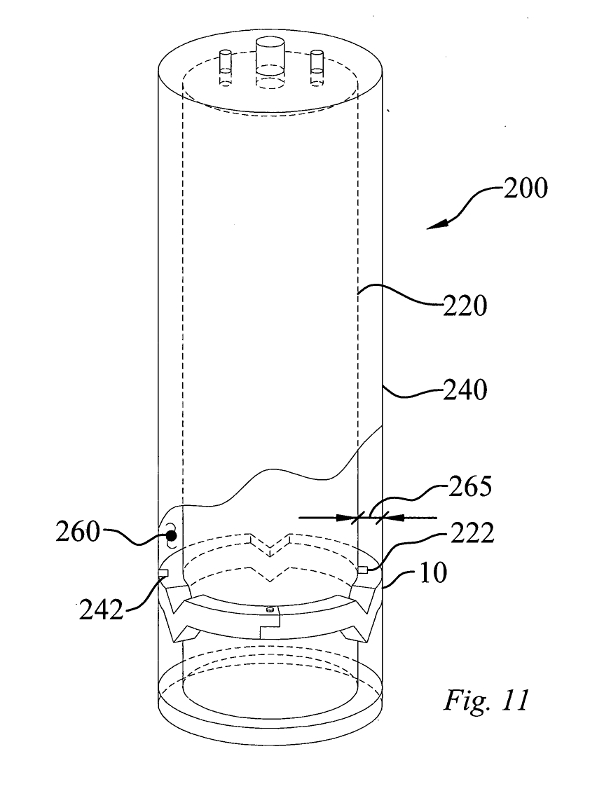

Such a sealing device (10) is well suited to the construction of an insulated tank assembly (200), such as seen well in FIGS. 11-12 and 16-17. Such an assembly (200) would generally comprise an inner tank (220) with an outer shell (240) located in spaced relation to and surrounding the inner tank (220). This spaced relation would define at least one annular clearance space (260) having at least one annular clearance space width (265) between the inner tank (220) and the outer shell (240), as seen well in FIGS. 11, 12, and 16.

A sealing device (10) including a sealing strip (100) as described above would lie in the at least one annular clearance space (260), again as seen well in FIGS. 11, 12, and 16, and would most commonly be placed by stretching a fully formed sealing strip (100) over the inner tank (220) and sliding it, including sliding it over any irregularities or protuberances in the inner tank (220), into position.

Commonly, but not necessarily, the sealing strip (100) would be located on the inner tank (220) and the outer shell (240) would be slid into place over the inner tank (220) and the sealing device (10). One skilled in the art will realize that in a common embodiment, that is, a circular tank (220) encased in a circular shell (240), the sealing strip (100) would generally have a uniform thickness in order to seal a uniform annular clearance space width (265) properly. However, there is no necessity for such a uniform annular clearance space width (265), as may be seen by reference to FIGS. 16-17. The construction detailed herein is equally suitable for structures having a plurality of annular clearance space widths (265), so long as the sealing device (10), as structurally described above, is disposed within the at least one annular clearance space (260) and substantially fills the at least one annular clearance space width (265), varying in thickness as necessary to conform to any variations in the annular clearance space width (265), such as is seen with a first annular clearance space width (266) and a second annular clearance space width (267), as seen well in FIG. 17.

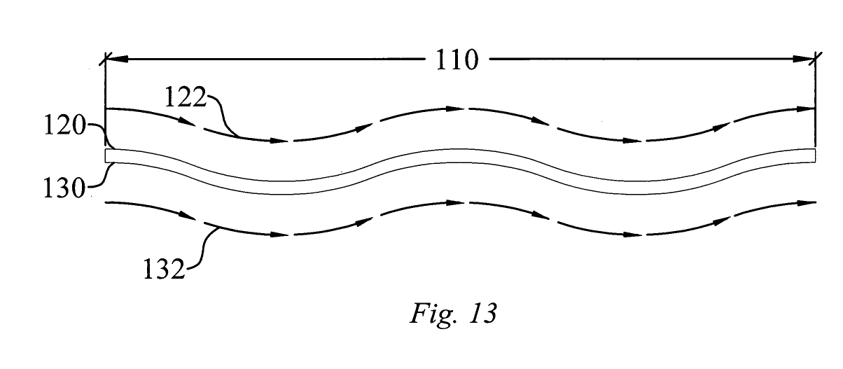

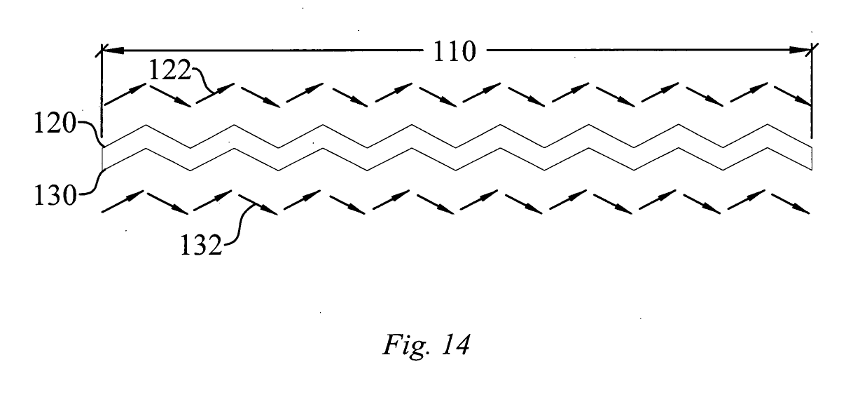

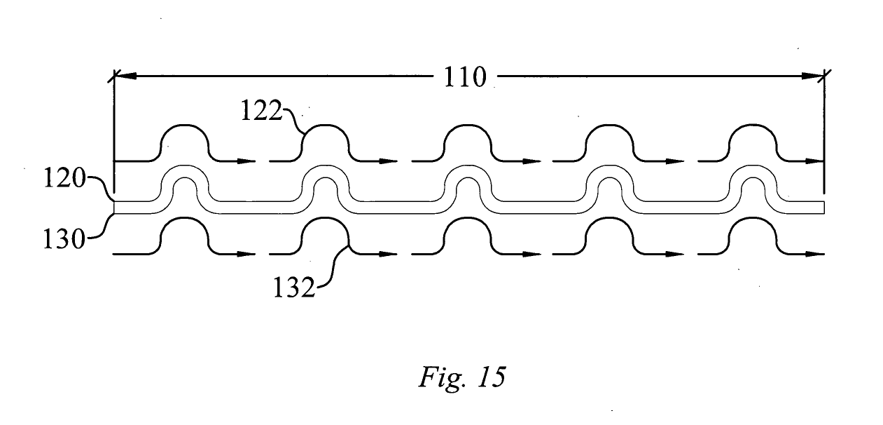

In such stretching and positioning maneuvers, a construction of the sealing strip (100) whereby the strip length (110) is less than one of the lengths selected from a group of lengths consisting of the continuous outer top edge length (122) and the continuous outer bottom edge length (132), or ideally both, may be desirable. One skilled in the art will appreciate, and it may be seen by contemplation of FIGS. 2a-11, that any construction where the strip length (110) is less than both the continuous outer top edge length (122) and the continuous outer bottom edge length (132), will have an intrinsically elastic nature, given at least a slightly elastic material substrate. For example, as can be easily envisioned from the embodiment of FIGS. 2a and 9, stretching the sealing strip (100) will cause the open v-like notches of what might be deemed the dentate portions of the strip to open slightly, and thereby to elongate the overall strip (100). Contemplation of FIGS. 2a-5 and 13-15 will show this is true with any construction in which the strip length (110) is less than one of the lengths selected from a group of lengths consisting of the continuous outer top edge length (122) and the continuous outer bottom edge length (132). For example, the serpentine-type construction seen in FIG. 13 elongates when the ends are pulled in opposite directions, as would the “zigzag” embodiment shown in FIG. 14, and/or the “opposing offsets” type construction as seen in FIG. 15. All these designs would therefore exhibit some degree of elasticity, given at least a minimally elastic substrate.

The construction in which the strip length (110) is less than either the continuous outer top edge length (122) or the continuous outer bottom edge length (132) also has advantages, although these advantages may be more limited. As described, sliding the outer shell (240) over the inner tank (220) while compressing the sealing strip (100) between the inner tank (220) and the outer shell (240) causes frictional interactions between the sealing strip (100), the walls of the inner tank (220) and the outer shell (240), that can cause the sealing strip to roll or otherwise be displaced from its intended position.

A construction whereby the strip length (110) is less than one of the lengths selected from a group of lengths consisting of the continuous outer top edge length (122) and the continuous outer bottom edge length (132) causes the strip (100) to have an innate resistance to rolling compared to the planar ring-like constructions seen in the prior art. This is due to the fact that a strip (100) in which the strip length (110) is less than either the continuous outer top edge length (122) or the continuous outer bottom edge length (132) is necessarily non-planar, that is, that all points on at least one of these edges do not lie on a single plane. In addition, in such a construction, not all points on the strip height midline are co-planar. In particular, it has been seen that the “dentate” construction as illustrated in FIGS. 2-11 is particularly resistant to rolling.

Constructions having multiple strip heights (112, 113) are also useful in deterring rolling. Those constructions where the sealing strip (100) has at least one strip height (112) and at least one secondary strip height (113), both measured as a vertical height between the top aspect (101) and the bottom aspect (103), and where the secondary strip height (113) is at least 10% greater than the strip height (112), are also resistant to rolling, as such constructions necessarily create non-coplanar surfaces.

Therefore since having the strip length (110) be less than one of the lengths selected from a group of lengths consisting of the continuous outer top edge length (122) and the continuous outer bottom edge length (132) causes the strip to have an innate resistance to rolling, and since having the strip length (110) be less than both of the lengths selected from a group of lengths consisting of the continuous outer top edge length (122) and the continuous outer bottom edge length (132) causes the strip to have an innate resistance to rolling and resilience; the latter construction may be more preferred in certain applications where the strip (100) is stretched over a rigid body.

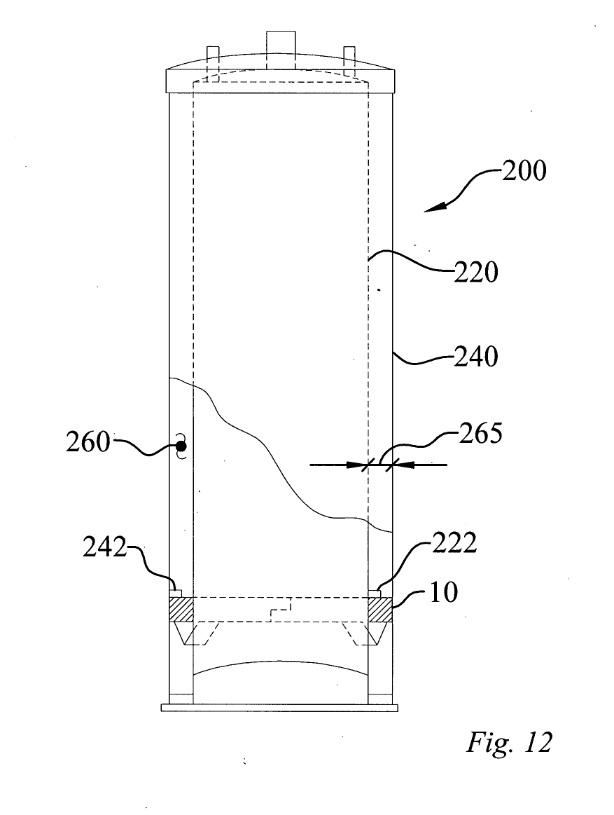

To assist the elastic nature of the strip (100) in keeping the sealing strip (100) in its predetermined position during assembly, the sealing strip (100) may be affixed to the inner tank (220) by, for example only, such means as adhesive, before the shell (240) is slid onto the tank (220). Additionally or alternatively, in other embodiments, as may be seen in FIGS. 11-12, the at least one annular clearance space (260) further includes one or more abutment members (222, 242), which may be formed as a simple ledge attached to either the inner tank (220) or the outer shell (240) and disposed in the annular clearance space (260), thus providing a positioning stop for the sealing device (10). A chamfer may be present along an edge selected from the edges consisting of the outer top edge (120) and the outer bottom edge (130) of the sealing strip (100) in order to ease the passage of the outer shell (240) over the inner tank (220).

Once the outer shell is in desired position, the tank assembly (200) may be insulated by placing insulating material within the at least one annular clearance space (260). In a common embodiment, the insulating material is a foamable insulation material, foamed in place within the annular clearance space (260). In order to retain such foam within the annular clearance space (260), the at least one strip thickness (116) has an uncompressed thickness slightly greater than the at least one annular clearance space width (265), and a compressed thickness essentially equal to the at least one annular clearance space width (265), within the annular clearance space (265). Thus, the sealing strip (100) creates a closed space within the annular clearance space (260) as seen well in FIGS. 11, 12, and 16.

Thus, the nature of the construction of the sealing device (10) and that of the insulated tank assembly (200) may be seen to lend itself to a method of assembling an insulated tank assembly (200) having an inner tank (220) and an outer shell (240) located in spaced relation to and surrounding the inner tank (220).

In order to define at least one clearance space (260) having at least one annular clearance space width (265) between the inner tank (220) and the outer shell (240), one skilled in the art may employ the steps of first forming a sealing device (10), such as seen in FIG. 2a-e, including a sealing strip (100) having a top aspect (101), an inner surface (102), a bottom aspect (103) and an outer surface (104). Such a sealing strip would have a strip length (110), at least one strip height (112) and at least one strip thickness (116); and as discussed, there may be variations in the strip height (112) and strip thickness (116) at different points in the sealing strip (100).

The sealing strip (100) may have an outer top edge (120) having a continuous outer top edge length (122) and an outer bottom edge (130) having a continuous outer bottom edge length (132), such as seen well in FIGS. 2a-10 and 13-15. To deter rolling, the strip length (110) is less than one of the lengths selected from a group of lengths consisting of the continuous outer top edge length (122) and the continuous outer bottom edge length (132). To both deter rolling and impart resilience, the strip length (110) may be less than either one of, the continuous outer top edge length (122) and the continuous outer bottom edge length (132), as seen in FIGS. 2a-5, 10, and 13-15.

Next, to continue the assembly, one skilled in the art would position the sealing device (10) circumferentially in contact with the inner tank (220) at a predetermined position on an external wall of the inner tank (220), as seen well in FIGS. 11 and 16. To assist the strip (100) in maintaining its predetermined position, the strip (100) may be affixed to the tank, or may utilize one or more abutment members (222, 242) as described above and seen in FIGS. 11-12, to aid in maintaining correct positioning. Similarly, the strip (100) may be chamfered, as above, to allow the outer shell (240) to slip more easily over the inner tank (220).

One would next place the outer shell (240) in spaced relation to and surrounding the inner tank (220) so as to define at least one annular clearance space (260) having at least one annular clearance space width (265) between the inner tank (220) and the outer shell (240). At this point, the sealing device (10) will be in contact with the inner tank (220) and the outer shell (240) and will substantially fill the at least one annular clearance space width (265), as seen well in FIGS. 11-12 and 15-16.

As discussed above, the sealing strip (100) may be formed of different layers (160, 170) and may have a facing layer (180). Such differential density layers (160, 170) and/or a facing layer (180) may allow one or both of the inner surface (102) and the outer surface (104) to be more dense, and thus easier to slide onto the inner tank (220), including sliding over any obstructions on the surface of the tank (220); or conversely to allow the outer shell (240) to slide more easily over the tank (220) and strip (100) during assembly.

Lastly, insulating the assembly may be completed by the step of filling the at least one annular clearance space width (265) with insulation material. In preferred embodiment, the insulation material may be a foamable insulation where the formable insulation material is injected into the annual clearance space (265) and allowed to foam and cure in place.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims.

We claim:

1. A sealing device comprising;
a circumferential sealing strip having a top aspect, an inner surface, a bottom aspect, an outer surface, a strip length, at least one strip height having a sealing strip height midline, at least one strip thickness, an outer top edge having a continuous outer top edge length, and an outer bottom edge having a continuous outer bottom edge length,
wherein the strip length is less than one of the lengths selected from a group of lengths consisting of the continuous outer top edge length and the continuous outer bottom edge length.

2. The device according to claim 1, wherein the continuous top edge length is greater than the strip length.

3. The device according to claim 1, wherein the continuous bottom edge length is greater than the strip length.

4. The device according to claim 1, wherein both the continuous top edge length and the continuous bottom edge length are greater than the strip length.

5. The device according to claim 1, wherein at least two points on the strip height midline are not coplanar.

6. The device according to claim 1, wherein the sealing strip has at least one strip height measured for any given radial point on the outer surface as a vertical height between the top aspect and the bottom aspect, and at least one secondary strip height measured for any given radial point on the outer surface as a vertical height between the top aspect and the bottom aspect, and wherein the secondary strip height is at least 10% greater than the strip height.

7. The device according to claim 1, wherein the sealing strip is a fibrous material strip made from a material selected from a group consisting of polyester, polyethylene, polypropylene, polyethylene terephthalate, glass fibers, natural fibers and any mixture thereof.

8. The device according to claim 1, wherein the sealing strip is a fibrous material strip made from a material selected from a group consisting of (a) thermoplastic polymer staple fibers and thermoplastic bicomponent fibers, (b) glass staple fibers and thermoplastic bicomponent fibers and (c) a combination of (a) and (b).

9. The device according to claim 8, wherein the sealing strip has a density of about 0.8 lbs./ft³ to about 15.0 lbs./ft³.

10. The device according to claim 1, wherein the sealing strip further comprises at least a first layer having a density of between about 1.5 lbs./ft³ to about 30.0 lbs./ft³ and a second layer having a density of between about 0.8 lbs./ft³ to about 15.0 lbs./ft³.

11. The device according to claim 1, wherein the sealing strip further comprises at least a first layer formed of fiberglass and a second layer formed of a polymer based material.

12. The device according to claim 1, wherein the sealing strip further comprises a facing layer on the sealing strip.

13. The sealing strip of claim 12, wherein the facing layer is selected from a group consisting of polyester, rayon, metallic foil and mixtures thereof.

14. The device according to claim 1, wherein the at least one strip thickness is about 2.110 cm to about 5.0120 cm.

15. The device according to claim 1, further comprising a first end and a second end wherein the first end and the second end are joined at a joining area.

16. The device according to claim 15, wherein the first end and the second end are adhesively joined at the joining area.

17. The device according to claim 15, wherein the joining area further includes a joining area fastener securing the first end and the second end at the joining area.

18. The device according to claim 17, wherein the joining area fastener is a tape.

19. An insulated tank assembly construction comprising:
an inner tank;
an outer shell located in spaced relation to and surrounding the inner tank so as to define at least one annular clearance space having at least one annular clearance space width between the inner tank and the outer shell;
a sealing device comprising a sealing strip having a top aspect, an inner surface, a bottom aspect, an outer surface, a strip length, at least one strip height, at least one strip thickness, an outer top edge having a continuous outer top edge length, and an outer bottom edge having a continuous outer bottom edge length, wherein the strip length is less than one of the lengths selected from a group of lengths consisting of the continuous outer top edge length and the continuous outer bottom edge length;
the sealing device being disposed within the at least one annular clearance space and substantially filling the at least one annular clearance space width; and
insulating material disposed within the at least one annular clearance space.

20. The assembly according to claim 19, wherein the at least one strip thickness has an uncompressed thickness slightly greater than the at least one annular clearance space width, and a compressed thickness essentially equal to the at least one annular clearance space width.

21. The device according to claim 19, wherein the at least one annular clearance space further includes at least one abutment member disposed in said annular clearance space and providing a positioning stop for the sealing device.

22. The device according to claim 19, wherein the insulating material is a foamable insulation material, foamed in place within the annular clearance space.

23. A method of assembling an insulated tank assembly having an inner tank and an outer shell located in spaced relation to and surrounding the inner tank so as to define at least one clearance space having at least one annular clearance space width between the inner tank and the outer shell, comprising the steps of;
forming a sealing device comprising a sealing strip having a top aspect, an inner surface, a bottom aspect, an outer surface, a strip length, at least one strip height, at least one strip thickness, a outer top edge having a continuous outer top edge length, and an outer bottom edge having a continuous outer bottom edge length, wherein the strip length is less than one of the lengths selected from a group of lengths consisting of the continuous outer top edge length and the continuous outer bottom edge length;
positioning the sealing device circumferentially in contact with the inner tank at a predetermined position on an external wall of the inner tank; and
placing the outer shell in spaced relation to and surrounding the inner tank so as to define at least one annular clearance space having at least one annular clearance space width between the inner tank and the outer shell, such that the sealing device is in contact with the inner tank and the outer shell and substantially fills at least a portion of the at least one annular clearance space width.

24. The method according to claim 23, further comprising the steps of filling the at least one annular clearance space width with a foamable insulation material, and allowing the formable insulation material to foam in place.

25. The method according to claim 23, further comprising the step of attaching the sealing device to the inner tank prior to placing the outer shell in spaced relation to and surrounding the inner tank.
